(19) United States
(12) Patent Application Publication
(10) Pub. No.: US 2008/0236614 A1
(43) Pub. Date: Oct. 2, 2008

(54) PLASMA PROCESSING APPARATUS AND PLASMA PROCESSING METHOD

(75) Inventors: Mamoru YAKUSHIJI, Shunan (JP); Yutaka Ohmoto, Hikari (JP); Yutaka Kouzuma, Kudamatsu (JP); Ken Yoshioka, Hikari (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/039,759

(22) Filed: Feb. 29, 2008

(30) Foreign Application Priority Data
Mar. 30, 2007 (JP) 2007-090407
Jan. 28, 2008 (JP) 2008-015755

(51) Int. Cl. B08B 3/00; C25F 3/00; B44C 1/22

(52) U.S. Cl. 134/1.1; 134/105; 156/345.52; 216/67

(57) ABSTRACT

A plasma processing apparatus includes a vacuum chamber, a processing chamber housed in the vacuum chamber, and a sample stage located in the processing chamber, for supporting on its upper surface a disk-like sample to be processed, wherein plural disk-like samples are continuously processed with plasma generated in the processing chamber and wherein during the idling time between the successive processes the temperature of the sample stage is adjusted to a predetermined value higher than the temperature at which the samples are processed.

### CROSS-REFERENCE TO RELATED APPLICATION

The present invention is related to U.S. patent application No. Ser. No. 11/846,899 filed Aug. 29, 2007 entitled “METHOD AND APPARATUS FOR PLASMA PROCESSING”.

### BACKGROUND OF THE INVENTION

This invention relates to an apparatus and a method for plasma processing wherein a disk-like sample such as a semiconductor wafer is placed in the processing chamber housed in a vacuum chamber and the sample is processed with plasma generated in the processing chamber, and more particularly to an apparatus and a method for plasma processing wherein the sample is placed on the temperature-controllable sample stage located in the processing chamber and the sample is processed while the temperature of the sample stage is being kept at values suitable for the process of the sample.

In the case where a disk-like sample such as a semiconductor wafer is processed with such a plasma processing apparatus as mentioned above, it is customary to keep the wafer at the optimal temperature while it is being processed so as to improve the working precision in wafer surface treatment. There are known a technique wherein the temperature of the sample is controlled by controlling the temperature of the coolant circulated in the sample stage on which the sample is placed, and a technique wherein the temperatures of the sample stage and the sample itself are controlled with a heater disposed in the sample stage.

Japanese patent documents, JP-A-2006-286733 and JP-A-2006-351887, disclose such conventional techniques as described just above. According to JP-A-2006-286733, the cooling medium to be fed into the coolant duct in the sample stage is heated by a heater provided in the coolant line leading to the coolant duct so that the cooling medium can be fed into the coolant duct after its temperature has been adjusted to a desired value.

According to JP-A-2006-351887, on the other hand, the temperature of the sample stage is adjusted to a desired value by controlling the temperature of the cooling medium passed through the sample stage on which the sample is placed. Namely, before processing the sample, the temperature of the sample stage is raised to temperatures to be reached in processing, then the temperature of the sample stage is adjusted to a desired value by lowering the temperature of the cooling medium, and finally the high frequency power starts being supplied to the electrode disposed within the sample stage.

### SUMMARY OF THE INVENTION

As the number of processed samples increases, byproducts produced as a result of having processed samples with plasma adhere to and accumulate on, the inner surface of the wall of the processing chamber housed in the vacuum chamber. As the accumulation of such byproducts proceeds, fragments may come off the accumulation, some fragments may be transferred within the processing chamber by being carried on some vehicle, and they may finally adhere onto the sample surface. Thus, they will become foreign materials which contaminate the processed samples and therefore reduce the yield in the process.

Also, such byproducts may adhere to the upper surface of the sample stage from which the sample is dismounted during the time between the end of processing one sample and the start of processing the next sample. Accordingly, when the next sample is placed on the sample stage in the next process, the byproducts may contaminate the lower surface of the sample. It is therefore necessary to prevent such byproducts from adhering to the sample stage to avoid the adverse influence due to the contamination with such byproducts. Those prior art techniques have not taken this point into consideration.

That is, though byproducts are emitted from a wafer during the etching process, some of them exit from the chamber via the exhaust duct but some others adhere to and accumulate on the wall of the reaction chamber and, after the etching process is finished and the wafer is taken out, the byproducts adhere to the electrode surface again. Although the amount of byproducts per one process is very small, thousands of etching processes will cause the byproducts to cover the electrode surface and, finally, will result in the generation of foreign materials. In addition, a variation in the roughness of the electrode surface caused by the byproducts changes the heat transfer coefficient of the wafer and the electrode surface, and a variation in the wafer temperature on a long-time basis causes a variation in the etching shape.

Namely, in the related art, no consideration is taken for the problem that byproducts generated in the etching process adhere to the surface of the sample stage and the processing precision in the next etching process is adversely affected. In addition, the same byproducts adheres to the surface of the sample stage also during the so-called no-wafer cleaning in which in-chamber dry cleaning is performed between each two wafer processes in order to remove the byproducts adhered to the wall of the reaction chamber. The usual method in the related art for suppressing the adherence of byproducts is to adjust the temperature of the coolant circulating inside the sample stage during the time before the process is started (idling time) or to perform plasma cleaning before the idling.

However, the change in the temperature of the coolant takes a relatively long time since the coolant has a large heat capacity, and this reduces the efficiency of process. Likewise, if plasma cleaning is performed during the idling time or before processing, it must be performed several times to render the upper surface of the sample stage free of contamination with byproducts, resulting in poor process efficiency. That is, the throughput has been very low with the conventional techniques wherein the removal of byproducts from the upper surface of the sample stage is attempted while the sample is not being processed.

In addition, when a wafer is taken out after the etching processing and exposed to air after a Si-series etching material is etched by HBr/C12/02-series gas or by fluoric gas such as SF6, CF4, or CHF3 combined with HBr/C12/02-seires gas, halogen remaining on the wafer surface reacts to the moisture in the air with the result that a large amount of foreign materials remains. This is the so-called an abnormal growth phenomenon. There is a need to prevent this phenomenon.

Another problem is generated when an etching material is formed by multi-layer composite films and those composite films are etched continuously in a single reaction chamber. In this case, when the etching step for one layer is finished, the plasma discharge is sometimes interrupted and, for several seconds to several tens of seconds, a new etching gas is supplied into the chamber and the pressure is readjusted in order to prepare for the etching step for the next layer. During this preparation time, there is a problem that the remaining gas or byproducts produced in the previous step but undesirable for etching in the next step adhere to the surface of the wafer.

The object of this invention is to provide a plasma processing apparatus or a plasma processing method wherein the process efficiency can be improved by suppressing the contamination of samples with byproducts.

The object of this invention can be achieved by a plasma processing apparatus that has a sample stage, which is provided in a processing chamber arranged in a vacuum chamber, for continuously processing a plurality of samples using plasma generated in the processing chamber, the plasma processing apparatus comprising the sample stage on which a disk-like sample to be processed is mounted; and an adjustment unit for adjusting a temperature of the sample stage to a predetermined value higher than a temperature at which the sample is processed during a processing time of the sample.

Also, the object of this invention can be achieved by a plasma processing method wherein plural disk-like samples, each of which is placed on the upper surface of the sample stage located in the processing chamber housed in the vacuum chamber, are continuously processed with plasma generated in the processing chamber, and wherein during the idling time between the successive processes the temperature of the sample stage is adjusted to a predetermined value higher than the temperature at which the samples are processed.

Further, the object of this invention can be achieved by adjusting the temperature of the sample stage to the predetermined value by a heater provided in the sample stage as the adjustment unit. Still further, the object of this invention can be achieved by choosing the predetermined value independently of the processing conditions under which the plural samples are processed.

Yet further, the object of this invention can be achieved by a film-like heater working as the adjustment unit and embedded in the dielectric film which is disposed on the upper surface of the sample stage and on which the sample is placed.

A plasma processing method wherein plural disk-like samples, each of which is placed on the upper surface of the sample stage located in the processing chamber housed in the vacuum chamber, are continuously processed with plasma generated in the processing chamber, and wherein during the idling time between the successive processes the temperature of the sample stage is adjusted to a predetermined one higher than the temperature at which the samples are processed.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows in vertical cross section the structure of a plasma processing apparatus as an embodiment of this invention;

FIG. 2 schematically shows in vertical cross section the structure of the sample stage used in the plasma processing apparatus shown in FIG. 1;

FIG. 3 shows in block diagram the circuit of a temperature control system for the sample stage shown in FIG. 2;

FIG. 4 is a table listing the conditions for the etching operation performed by the plasma processing apparatus shown in FIG. 1;

FIG. 5 shows the steps of a procedure carried out between two successive lots by the plasma processing apparatus shown in FIG. 1;

FIG. 6 graphically shows the change with time in the temperature of the sample stage used in the plasma processing apparatus shown in FIG. 1;

FIG. 7 shows the steps of a procedure carried out for a lot by the plasma processing apparatus shown in FIG. 1;

FIG. 8 graphically shows the change with time in the temperature of the sample stage used in the plasma processing apparatus shown in FIG. 1;

FIG. 9 graphically shows the change with time in the temperature of the sample stage used in the plasma processing apparatus shown in FIG. 1;

FIG. 10 shows the steps of a procedure carried out for no-wafer cleaning by the plasma processing apparatus shown in FIG. 1;

FIG. 11 graphically shows the change with time in the temperature of the sample stage used in the plasma processing apparatus shown in FIG. 1;

FIG. 12 graphically shows the change with time in the temperature of the sample stage used in the plasma processing apparatus shown in FIG. 1; and

FIG. 13 graphically shows the change with time in the temperature of the sample stage used in the plasma processing apparatus shown in FIG. 1.

FIG. 14 shows an example of the sequence of processes including the degassing process after the processing of the plasma processing apparatus in the embodiment shown in FIG. 1 is finished.

FIG. 15 graphically shows a change in the temperature of the sample stage in the embodiment shown in FIG. 14.

FIG. 16 shows an example of the flow of sequence of the processes after one of two processing steps of the processing of the plasma processing apparatus in the embodiment shown in FIG. 1 is finished and before the next processing step is started.

FIG. 17 graphically shows a change in the temperature of the sample stage in the embodiment shown in FIG. 16.

### DETAILED DESCRIPTION OF THE EMBODIMENT

The recent increase in the scale of integration in semiconductor devices has accompanied the further miniaturization of the structure of each circuit element of an electronic device. Consequently, the circuit element which could be built in a single layer in the past, has come to be built in a layer structure consisting of plural layers stacked one upon another to meet a requirement of improving operational characteristics. In the field of printed circuit boards, for example, material for wiring conductor has been aluminum and the wiring conductor has been of single layer. However, the recent requirement for improving the operational reliability and the resolution in advanced photographic technique, has made it necessary to replace the conventional aluminum single layer by a composite layer, or laminated, structure consisting of an upper and a lower layers of titanium nitride with aluminum layer interposed between them. Further, the recent requirement for increasing the switching speeds of transistors and decreasing the consumption of power in transistors, has made it customary to build the gate electrode in a laminated structure. For example, the typical structure is a resist mask /BARC/SiN/polySi/Ta/Hf02 and so on.

In the case where such a laminated structure is worked with etching throughout, the temperature of the sample stage having an electrode therein (hereinafter referred to as a sample stage) is adjusted by circulating coolant through the coolant duct cut in the sample stage. This temperature control is necessary since working precision can be improved by adjusting the temperature of wafer to the optimal value during etching operation. When the etching operation is completed, the wafer is dismounted from the sample stage and transferred out of the processing chamber. During the idling time (while etching operation is interrupted until the next etching operation is resumed), the temperature of the coolant circulating through the duct in the sample stage is kept at the same temperature as that of the coolant maintained during etching operation. Now, if the temperature of the coolant through the sample stage is lower than the temperature of the material of which the processing chamber is made, then the byproducts produced during the etching operation adhere to the sample stage. When a new wafer is mounted on the sample stage for the next etching operation, the byproducts deposited on the sample stage contaminates the new wafer so that etching characteristic may be adversely affected.

Conventionally, during the idling time, it is customary to suppress the adhesion of byproducts onto the sample stage by adjusting the temperature of the coolant through the sample stage to a relatively high value. However, it takes about 10 to 100 minutes to raise the temperature of the circulating coolant and the temperature of the whole sample stage high enough to suppress the adhesion of byproducts and it also takes the same time to adjust the coolant temperature to the optimal value for the following etching operation. Further, plasma cleaning is performed after each etching operation so as to suppress the adhesion of byproducts onto the sample stage during the idling time. Thus, according to the related art, considerable time is needed to suppress the adhesion of byproducts onto the sample stage during the idling time and therefore the throughput of the process is very poor. Therefore, there has been need for a procedure capable of suppressing the adhesion of byproducts onto the sample stage without lowering the throughput of process.

In addition, when a wafer is taken out after the etching processing and exposed to air after a Si-series etching material is etched by HBr/C12/02-series gas or by fluoric gas such as SF6, CF4, or CHF3 combined with HBr/C12/02-seires gas, halogen remaining on the wafer surface reacts to the moisture in the air with the result that a large amount of foreign materials remains. This is the so-called an abnormal growth phenomenon. There is a need to prevent this phenomenon.

Another problem is generated when an etching material is formed by multi-layer composite films and those composite films are etched continuously in a single reaction chamber. In this case, when the etching step for one layer is finished, the plasma discharge is sometimes interrupted and, for several seconds to several tens of seconds, a new etching gas is supplied into the chamber and the pressure is readjusted in order to prepare for the etching step for the next layer. During this preparation time, there is a problem that the remaining gas or byproducts produced in the previous step but undesirable for etching in the previous step adhere to the surface of the wafer.

The embodiments of this invention have been made to meet such industrial requirements and its constitution, usages and advantages will be explained in the following by way of embodiments.

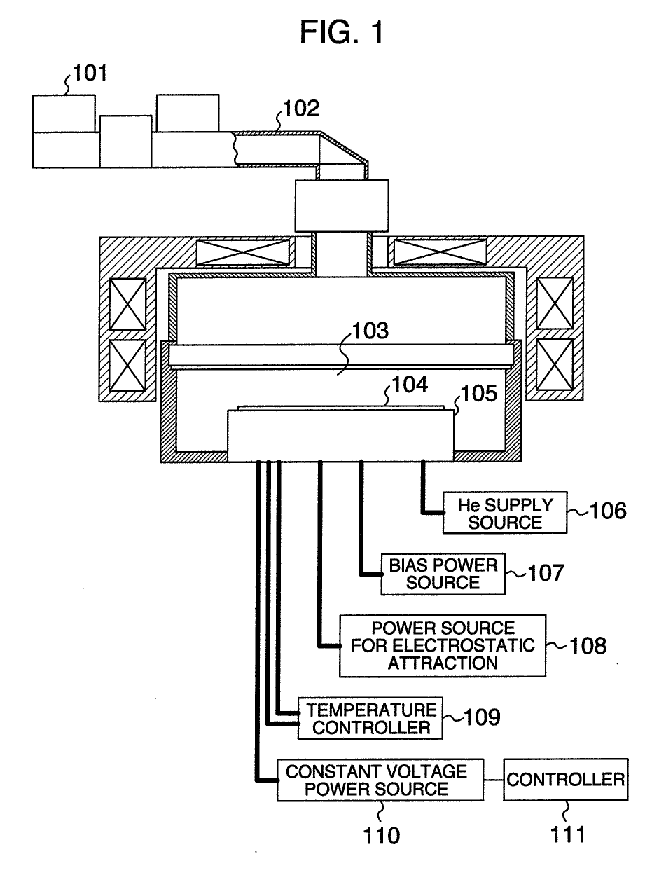

The embodiments of this invention will now be described below with reference to the attached drawings. FIG. 1 schematically shows in vertical cross section the structure of a plasma processing apparatus as an embodiment of this invention.

In the plasma processing apparatus shown as an embodiment of this invention in FIG. 1, microwaves generated by a microwave generating source 101 are propagated through a waveguide 102. A processing chamber 103 is communicated with an evacuating system (not shown) and a gas feed system (not shown) so that the internal of the processing chamber 103 can be depressurized to a pressure condition suitable for plasma processing. Gas fed into the processing chamber 103 is turned into plasma by being excited by the microwaves guided into the processing chamber 103. Accordingly, a disk-like sample 104 (hereafter referred to as wafer) to be processed can be subjected to a desired plasma processing. Alternatively, plasma may be generated by the inductive coupling procedure using high frequency electric power or the electrostatic coupling procedure using high frequency electric power, in place of the above mentioned procedure using microwaves.

The wafer 104, which is a sample to be processed, is mounted on a sample stage 105 and a bias potential is applied to the sample stage 105 from a bias power source 107 connected thereto. Accordingly, ions in the plasma bombard the surface of the wafer 104 to perform plasma processing. Further, the sample stage 105 is coupled to a helium (He) supply source 106, which is a heat transfer gas, for securing the heat transfer between the wafer 104 and the electrode 105, a DC power source 108 for electrostatic attraction, a constant voltage power source 110 for controlling the heater temperature and a temperature controller 109 for circulating temperature-controlled coolant through the sample stage 105 to cool the body of the electrode 105. The constant voltage power source 110 is also connected with a controller 111 for determining the output voltage of the constant voltage power source 110.

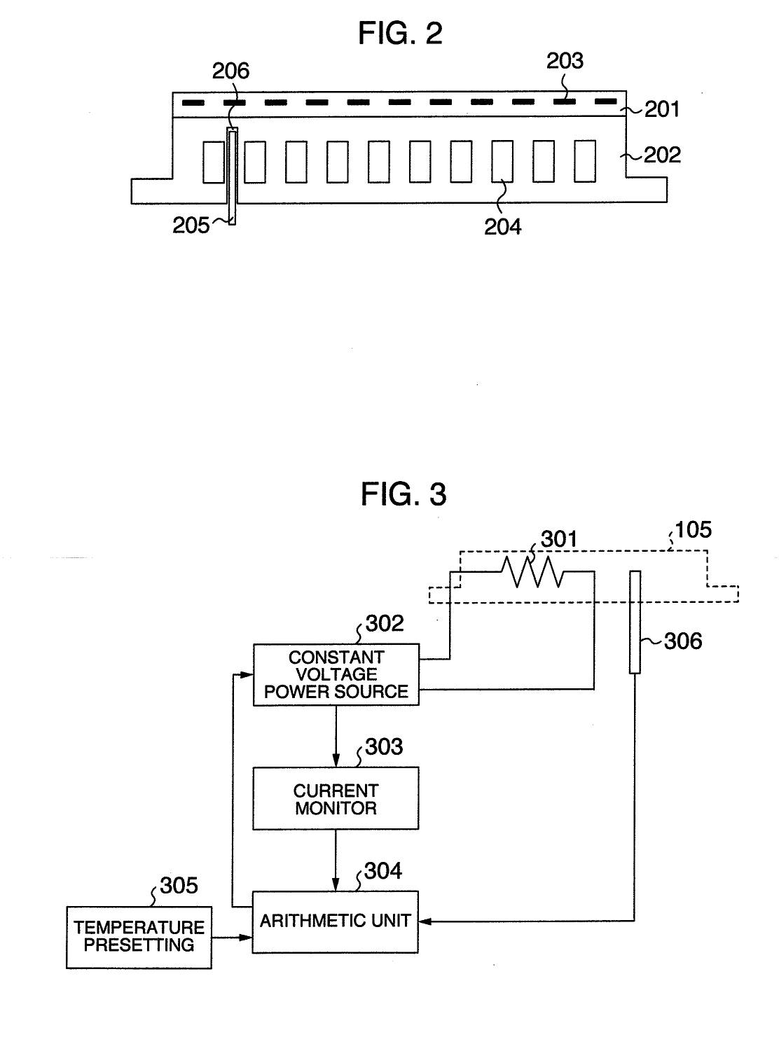

FIG. 2 schematically shows in vertical cross section the structure of the sample stage 105 used in the plasma processing apparatus shown in FIG. 1. The sample stage 105 consists mainly of a head plate 201 and a cooling plate 202. The head plate 201 is made of insulating material and has a heater 203 for heat generation embedded therein. The heater 203 is connected with the constant voltage power source 110 shown in FIG. 1. In the cooling plate 202 is cut a coolant passage 204 through which the coolant, whose temperature is controlled by the temperature controller 109 shown in FIG. 1, is passed. A small hole is bored in a lower peripheral portion of the cooling plate 202 and a temperature sensor 205 is inserted in the small hole.

The cooling plate 202 may have a film structure built by laminating an insulating material and a heater-resistant material through spraying. In this case, an in-plate adhesive such as silicon grease is not necessary.

FIG. 3 shows a block diagram of a temperature control system for controlling the power source that supplies power to the heater 203 shown in FIG. 2. A constant voltage power source 302, connected to a heater resistor 301 composed of an electric resistor, controls the temperature of the sample stage 105 by receiving the voltage command signal from an arithmetic unit 304 and applying an appropriate voltage to the heater resistor 301. The arithmetic unit 304 delivers the voltage command signal for keeping the sample stage 105 at a preset temperature 305 depending on the output signals of a current monitor 303 and a temperature sensor 306. Accordingly, the wafer 104 or the sample stage 105 is adjusted to a desired temperature. Thus, the temperature control system consists of a single signal loop.

In one example of the design, the speed of the response to a change in the temperature of the surface of the sample stage 105 in which the heater 203 described above is built can be set in the range of 5° C.-20° C./second. In this case, using the maximum power of 2000W-5000W for the power supplied to the heater 203 and maintaining the temperature of the coolant supplied to the cleaning plate in the range of 0° C.-40° C. can make the response speed equal between a temperature rise and a temperature fall.

Description will now be made of an embodiment of this invention which relates to a method wherein power is supplied to the heater 203 (heater resistor 301) in the sample stage 105 during the idling time, during which the sample is not processed in this embodiment, to raise the temperature of the electrode 105 for suppressing the adhesion of byproducts. First, after the completion of etching process, the dismounting of the wafer 104 from the sample stage 105 is started. The wafer 104 is dismounted as follows. The multiple vertically-moving pusher pins (not shown) are provided in the sample stage 105 with their tips inside the sample stage 105. When the dismounting is started, the pusher pins move upward, lift the wafer 104 from the upper surface of the head plate 201 of the sample stage 105, and hold it with a predetermined spacing between the wafer 104 and the sample stage 105. After that, the dismounting robot arm (not shown) moves into the spacing and stops below the wafer 104. When the robot arm stops, the pusher pins move downward to place the wafer 104 on the upper surface of the arm.

When there is no wafer 104 on the sample stage 105 as described above and the wafer 104 is not processed by the plasma, that is, during the idling time, a voltage is applied to the heater 203. As shown in FIG. 3, since the voltage applied to the heater resistor 301 from the constant voltage power source 302 is controlled by the arithmetic unit 304 depending on the output signal of the temperature sensor 306, that is, since this control is performed by a signal loop consisting of the circuit elements 301, 302, 304 and 306, the upper surface of the sample stage 105, which has the head plate 201 containing the heater 203 composed of the heater resistor 301, is heated up to a preset temperature 305 very quickly, for example, within 5 to 10 seconds, and kept stably at the preset temperature 305 thereafter. The preset temperature 305 is preferably a temperature high enough to suppress the adhesion of byproducts or to volatilize byproducts and the upper surface of the sample stage 105 or the wafer 104 is always kept at the preset temperature all through the idling time. Immediately before the start of the next etching operation, the supply of power to the heater 203 in the sample stage 105 is stopped so that the temperature of the sample stage may be adjusted to a value suitable for etching.

Although the temperature of the sample stage 105 or the wafer 104 suitable for preventing the adhesion of byproducts depends on the etching material and the etching gas that is used, the suitable temperature for a Si-series etching material is 40° C.-120° C. and that for a metal-series etching material is also 40° C.-120° C.

The operation of the heater 203 may be controlled in such a manner that the temperature at which the sample stage 105 is maintained during the idling time is realized by obtaining through a communication means the value that is preset by a user depending on the sorts and structure of layers in the surface of the wafer 104 and that is stored in a memory device (not shown). Alternatively, a control device including the controller 111 of the plasma processing apparatus may control the heater 203 on the basis of the command data (recipe) for controlling the operations related to plural conditions for processing plural wafers 104, the command data (recipe) previously including the temperature at which the sample stage 105 is maintained during the idling time.

According to this embodiment, the temperature of the sample stage 105 or the temperature of its upper surface during the idling time can be set independent of the processing conditions including the temperatures of the wafers treated before and after the idling time and the status of the apparatus in operation. For example, the control device, which receives the signals transmitted from the sensors located at various points in the plasma processing apparatus, may calculate the value of temperature at which the sample stage 105 is maintained on the basis of the system parameters derived from the received signals or the value of the temperature may be read out of a memory device. Therefore, the operating mode of the plasma processing apparatus during processing the wafer 104 and the operating mode of the plasma processing apparatus during the idling time between successive processes, are set independent of each other. In the embodiment described below, the temperature at which the sample stage 105 is maintained during the idling time is set constant for plural wafers, independent of the temperatures at which the wafers are processed.

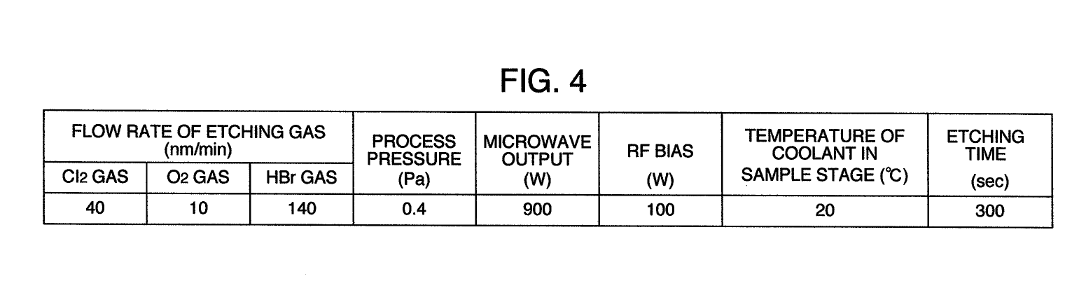

The effect of suppressing the adhesion of byproducts onto the surface of the sample stage 105 will now be recognized according to this embodiment. FIG. 4 is a table listing the conditions for the etching operation performed by the plasma processing apparatus shown in FIG. 1. Twenty-five bare wafers of silicon were processed successively under the etching conditions as shown in FIG. 4. Then, during the idling time thereafter, a raw silicon bare wafer was placed on the sample stage 105 for experiment so as to indirectly measure the amount of byproducts deposited on the sample stage 105. The idling time was set to be 24 hours and the thickness of the film-like deposition of byproducts adhering to the raw silicon bare wafer during the idling time was measured by an optical instrument for measuring film thickness. The temperature of the coolant for cooling the sample stage 105 during the idling time was set at the same value as that of the sample stage given in the table shown in FIG. 4. During etching process, no voltage is applied to the heater resistor and the temperature control is performed only by the coolant flowing through the sample stage.

According to this embodiment, the preset temperature at which the sample stage 105 is kept during the idling time was 40° C. When this embodiment was not applied, the film thickness of the byproducts deposited on the silicon bare wafer during the idling time was 30 nm. On the other hand, when this embodiment was applied, the film thickness of the byproducts deposited on the silicon bare wafer during the idling time was 0 (zero) nm. Therefore, it can be concluded that the adhesion of byproducts onto the surface of the sample stage 105 is suppressed if the temperature of the sample stage 105 is set higher than 40° C. Further, the same result was obtained when this embodiment was applied to the cleaning process for each lot where there is no wafer existing in the processing chamber.

As described above, actually applying the temperature control in this embodiment to the actual processing of laminated films produces a processed shape that is vertical and has few transfer errors even after a long idling time. The same effect is achieved also during the idling time when the wafer 104 is mounted or dismounted for a short time while the continuous etching processing is performed and during the time the no-wafer, in-lot cleaning is performed.

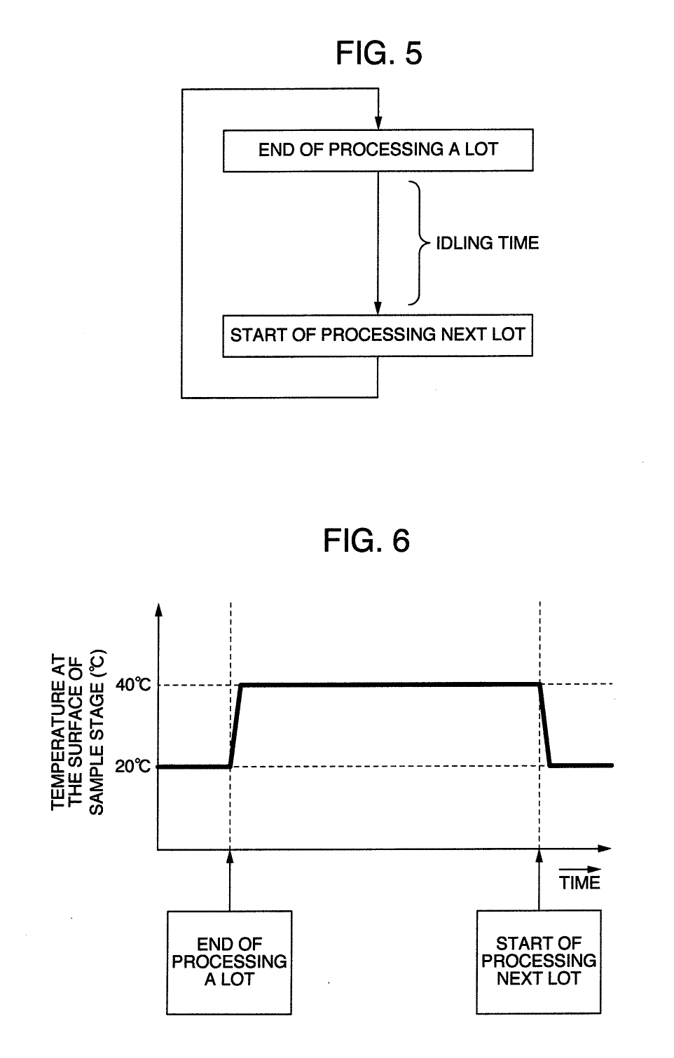

Now, description will be made of a case where this embodiment is applied during the idling time between two successive lots. FIG. 5 shows the steps of a procedure carried out between two successive lots by the plasma processing apparatus shown in FIG. 1. The temperature of the sample stage 105 was controlled by the heater 203 during the idling time between the end of processing a lot and the start of processing the next lot. FIG. 6 graphically shows the change with time in the temperature of the sample stage 105, illustrating how the temperature of the sample stage is controlled by the heater 203 during the idling time between two successive lots. In this case, the temperature of the sample stage 105 was maintained at 20° C., which is the temperature suitable for etching process, until the end of processing a lot. And as soon as the process of this lot had been finished, the temperature of the sample stage 105 was very quickly elevated to 40° C. by energizing the heater. During the idling time between this lot and the next lot, the temperature of the sample stage 105 was kept at 40° C. by means of the heater. Simultaneously with the start of processing the next lot, the temperature of the sample stage 105 was lowered to 20° C. which is the temperature suitable for etching process. Thus, the adhesion of byproducts onto the surface of the sample stage 105 could be suppressed by maintaining the sample stage 105 at a relatively high temperature during the idling time between two successive lots.

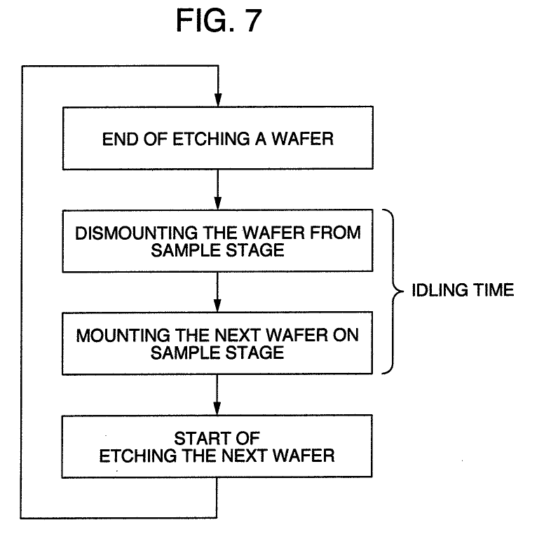

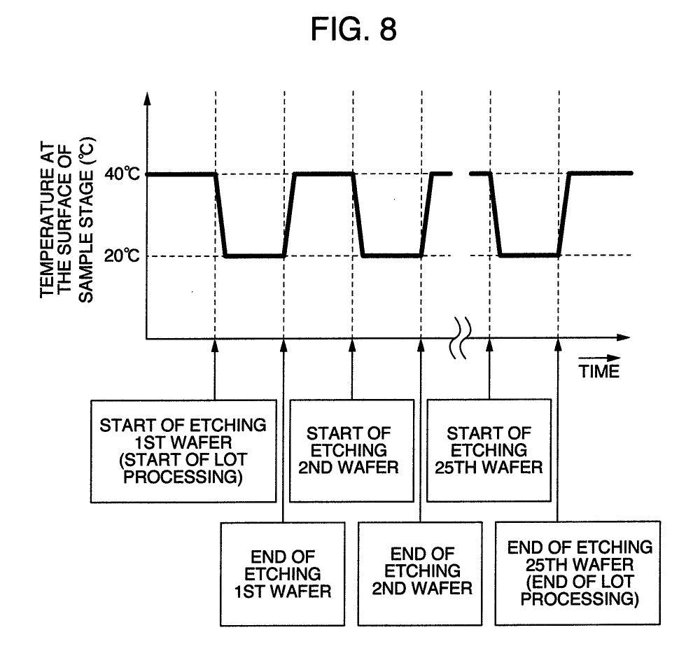

Further, description will be made of a case where this embodiment is applied while a single lot is in process. FIG. 7 shows the steps of a procedure carried out for a lot by the plasma processing apparatus shown in FIG. 1. The temperature of the sample stage 105 was controlled by the heater during the idling time between the end of etching a wafer and the start of etching the next wafer. FIG. 8 graphically shows the change with time in the temperature of the sample stage 105, illustrating how the temperature of the sample stage 105 is controlled by the heater 203 during the idling time between two successive wafer etching processes. In this case, at the start of etching the wafer, the temperature of the sample stage 105 was kept at 20° C. which is the temperature suitable for etching process. At the end of etching this wafer, the temperature of the sample stage 105 was very quickly elevated to 40° C. by energizing the heater. During the idling time while the same lot was in process, the temperature of the sample stage 105 was kept at 40° C. by energizing the heater. Simultaneously with the start of etching the next wafer, the temperature of the sample stage was lowered to 20° C. which is the temperature suitable for etching process.

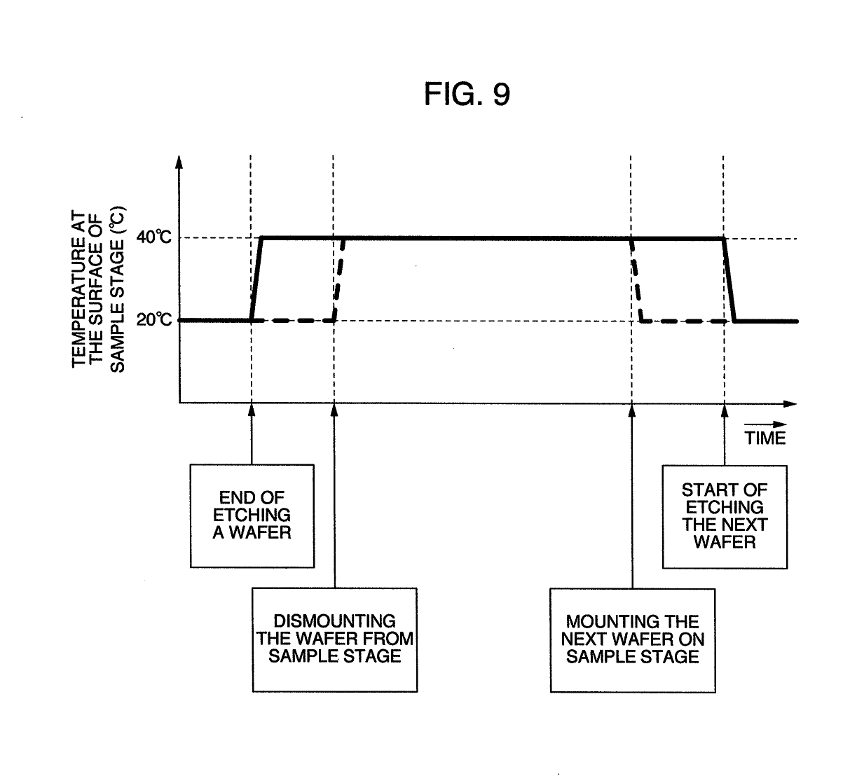

FIG. 9 graphically shows the change with time in the temperature of the sample stage 105, illustrating how the temperature of the sample stage 105 is controlled by the heater 203 during the idling time between two successive wafer etching processes in the single lot. As described above, the temperature of the sample stage 105 was very quickly elevated simultaneously with the end of etching a wafer, but the temperature of the sample stage 105 may be very quickly elevated to 40° C. by energizing the heater as soon as the wafer has been dismounted from the sample stage 105 sometime after the end of etching the wafer, as indicated with dotted line in FIG. 9. Further, as described above, the temperature of the sample stage 105 was lowered to 20° C., which is the temperature suitable for etching process, simultaneously with the start of etching the next wafer. But the temperature of the sample stage 105 may be lowered to 20° C., which is the temperature suitable for etching process, as soon as the next wafer has been mounted on the sample stage 105, as indicated with dotted line in Fog. 9. Thus, the adhesion of byproducts onto the surface of the sample stage 105 could be suppressed by maintaining the sample stage 105 at a relatively high temperature during the idling time between the processes of etching two successive wafers while the same lot was in process.

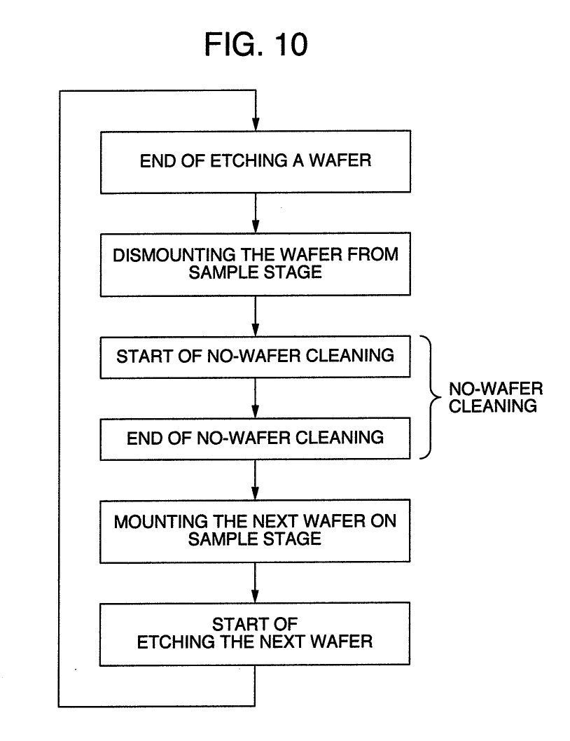

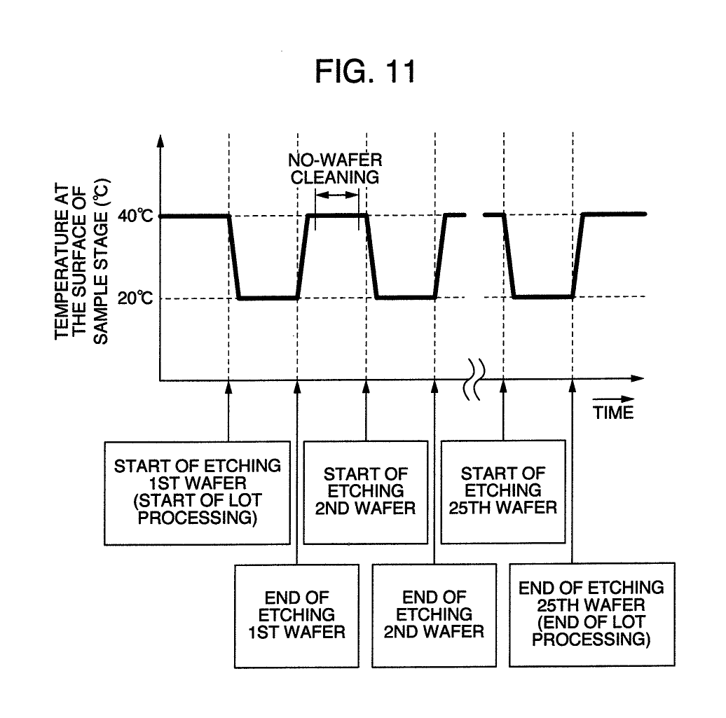

Below is described a case wherein this embodiment was applied to the cleaning process for each lot where there is no wafer existing in the processing chamber. FIG. 10 shows the steps of a procedure carried out for the cleaning process for each lot where there is no wafer existing in the processing chamber. For the brevity of expression, the “cleaning process for each lot where there is no wafer existing in the processing chamber” will be hereafter referred to as the “no-wafer cleaning”. The temperature of the sample stage 105 was controlled by the heater during the no-wafer cleaning time between the end of etching a wafer and the start of etching the next wafer. FIG. 11 graphically shows the change with time in the temperature of the sample stage 105, illustrating how the temperature of the sample stage is controlled by the heater 203 during the no-wafer cleaning process for each lot. In this case, the temperature of the sample stage 105 was kept at 20° C., which is the temperature suitable for etching process, at the start of etching a wafer and the temperature of the sample stage 105 was very quickly elevated to 40° C. by energizing the heater at the end of etching the wafer. During the no-wafer cleaning time that follows, the temperature of the sample stage 105 was kept at 40° C. by energizing the heater. It was then lowered to 20° C., which is the temperature suitable for etching process, simultaneously with the start of etching the next wafer.

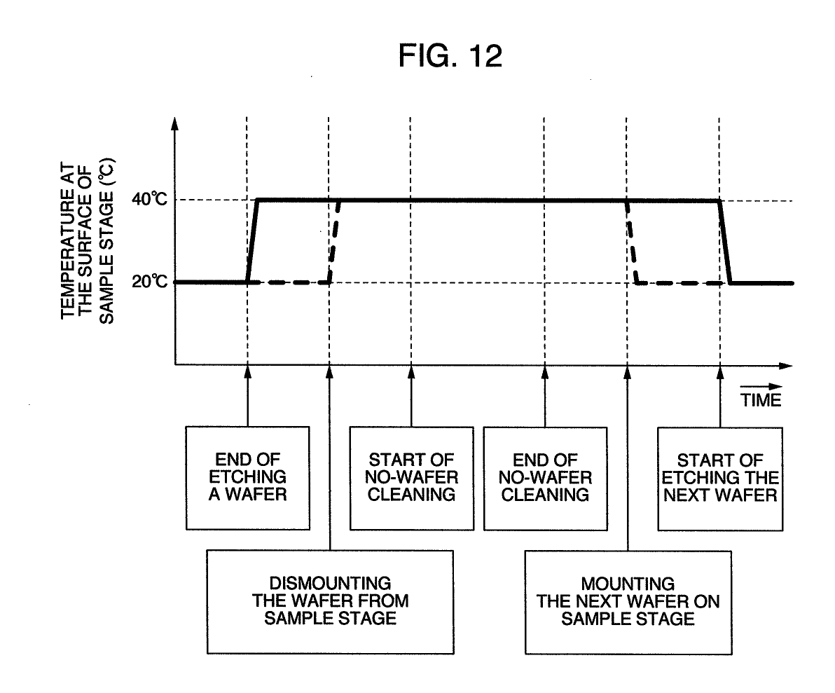

In addition, FIG. 12 graphically shows the change with time in the temperature of the sample stage 105 in another case, illustrating how the temperature of the sample stage is controlled by the heater 203 during the no-wafer cleaning process for each lot. As described above, the temperature of the sample stage 105 was very quickly elevated simultaneously with the end of etching a wafer. But it may be very quickly elevated to 40° C. by energizing the heater as soon as the wafer has been dismounted from the sample stage 105 after the end of etching the wafer, as indicated with dotted line in FIG. 12. Also, as described above, the temperature of the sample stage was lowered to 20° C., which is the temperature suitable for etching process, simultaneously with the start of etching the next wafer. But it may be lowered to 20° C., which is the temperature suitable for etching process, as soon as the next wafer has been mounted on the sample stage, as indicated with dotted line in FIG. 12. Thus, the adhesion of byproducts onto the surface of the sample stage 105 could be suppressed by maintaining the sample stage 105 at a relatively high temperature during the no-wafer cleaning process for each lot.

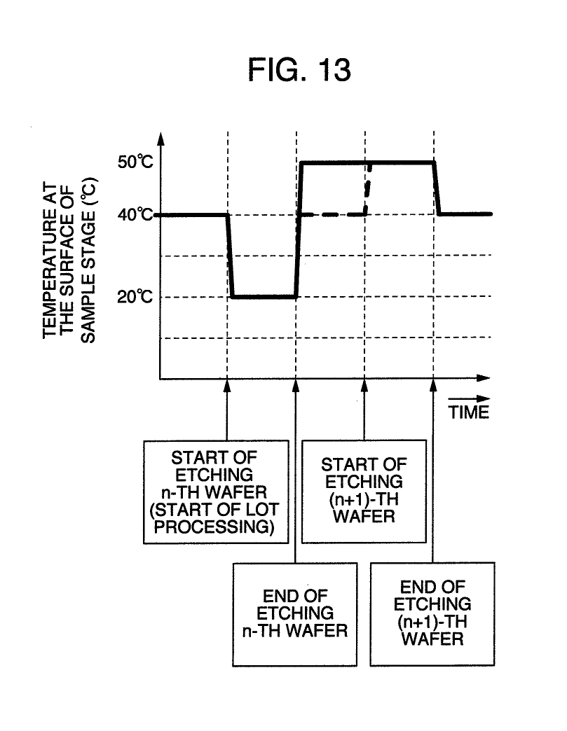

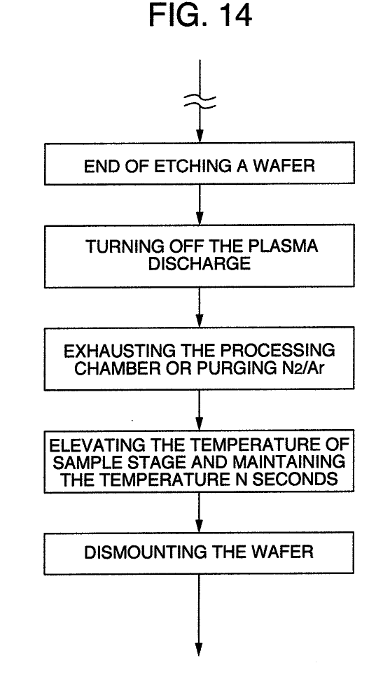

Another embodiment of this invention will be described below wherein the temperature of the sample stage 105 is changed whenever every n wafers have been etched in a lot. FIG. 13 graphically shows the change with time in the temperature of the sample stage, illustrating how the temperature of the sample stage is controlled by the heater 203. When the optimal temperature of the sample stage for etching the n-th wafer was supposed to be 20° C., the temperature of the sample stage 105 was kept at 40° C. during the idling time immediately before etching the n-th wafer. When the optimal temperature of the sample stage for etching the (n+1)-th wafer was supposed to be 50° C., the temperature of the sample stage 105 was kept at 50° C. during the idling time immediately before etching the (n+1)-th wafer. Moreover, as indicated with dotted line in FIG. 13, while the temperature of the sample stage was kept at 40° C. during the idling time immediately before etching the (n+1)-th wafer, the temperature of the sample stage may be elevated to 50° C., which is the temperature suitable for etching the (n+1)-th wafer, by energizing the heater simultaneously with the start of etching the (n+1)-th wafer. Thus, the adhesion of byproducts onto the surface of the sample stage 105 could be suppressed even when the temperature of the sample stage 105 is changed whenever every n wafers have been etched in a lot.

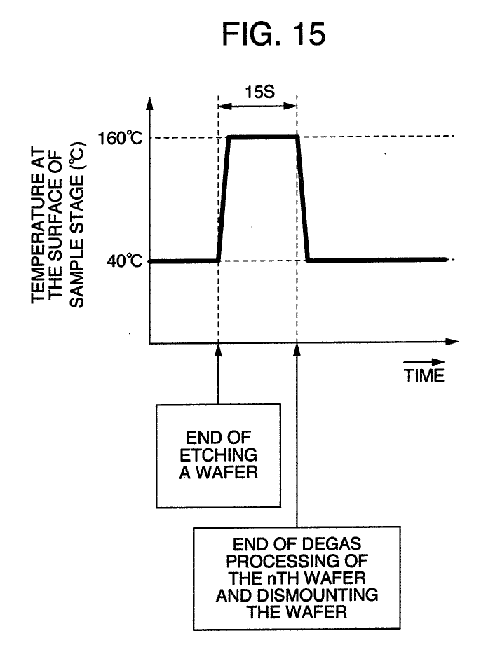

Next, the following describes an embodiment in which an abnormal growth, generated by the processing gas adhered to the wafer 104 after the processing of the wafer 104, is suppressed. FIG. 14 shows an example of the degassing process after the etching processing is finished. FIG. 15 shows an example of the temperature control when the degassing processing process is performed after the etching is finished. In this example, with the assumption that the temperature when the etching processing is finished is 40° C., the electrode temperature is raised to 160° C. after the discharge is turned off and this temperature is maintained for a predetermined time of N seconds, for example, 15 seconds. After that, the wafer 104 is removed from the upper surface of the sample stage 105 for dismounting it.

This configuration is provided for use when the gas including Halogen-series gas (such as HBr, BC13, SF6, CF4, and CHF3) is used as the etching processing gas. In this case, the gas adheres to the surface of the wafer 14 and, after the wafer is exposed to the air, the adhered gas reacts to the moisture in the air and causes corrosion or produces foreign materials. This configuration solves the problem of the corrosion and the foreign materials. In the related art, a heating container such as a heating chamber is used to degas the adhered gas. This method in the related art has a drawback that the number of chambers is increased and the apparatus cost is increased. In this embodiment, after one wafer 104 is processed and before the next wafer 104 is processed, the surface of the sample stage 105 on which the wafer 104 is mounted is raised and the above-described gas substance remaining on the wafer 104 is volatilized and removed to prevent corrosion. A rise in the temperature required after the processing is finished, though dependent on the condition, is preferably in the range of 80° C.-160°. The time for maintaining the high temperature, also dependent on the condition, is preferably 10 seconds to 100 seconds.

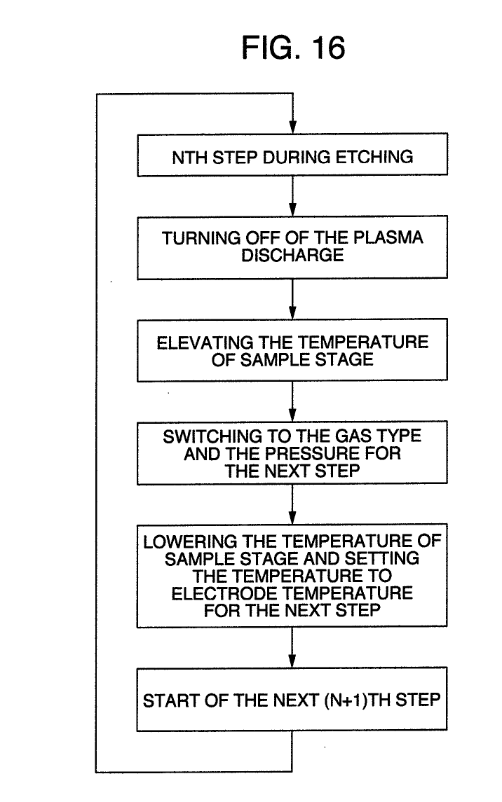

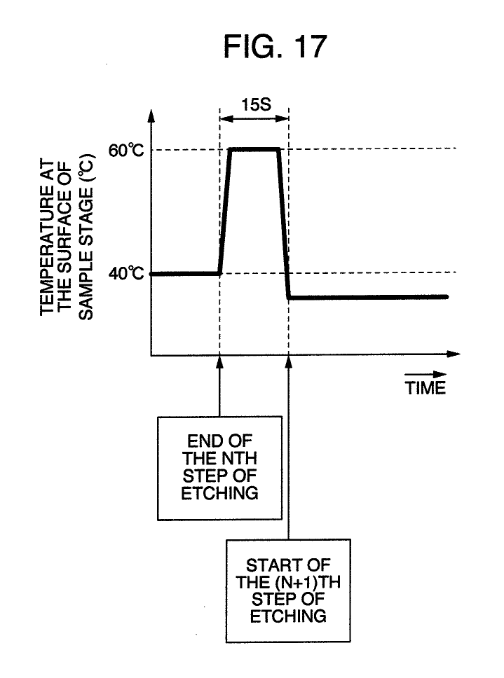

Next, the following describes an embodiment in which the temperature of the wafer 104 or the sample stage 105 is changed in the preparation period between the steps when the film structure on the wafer 104 is processed by two or more continuous steps. FIG. 16 shows the flow of the operation in which one of two processing steps is finished and, after that, the next processing step is started. FIG. 17 shows an example of the temperature control of the wafer 104 or the sample stage 105 where the discharge is interrupted between the steps in the operation shown in FIG. 16.

In this embodiment, with the assumption that the temperature when the Nth step is finished is 40° C., the discharge related to the Nth step processing is stopped and the plasma is turned off and, after that, the temperature of the sample stage 105 is raised to 60° C. and this temperature is maintained for a predetermined period, for example, 15 seconds. The discharge is interrupted at step switching time to continuously perform the etching processing for the film structure of multiple vertically-laminated films. For example, the discharge is interrupted when the etching processing step for the BARC film is finished and the processing is switched to the etching processing step for the SiN film that is immediately below or when the etching step for the upper SiN film layer is finished and the processing is switched to the next step for etching the polysi(polysilicon) film layer.

When the discharge is interrupted, the remaining gas existing in the processing chamber 103 and used in the previous step is exhausted, the processing chamber 103 is adjusted to the atmosphere of the gas to be used in the next step, and the byproduct gas atmosphere in the previous step is exhausted. If the gas switching at the discharge interrupt time is performed at the electrode temperature used in the step in the related art, the byproducts adhered to the wafer 104 or the remaining etching gas is not removed but remains. This improper gas switching sometimes affects the processing in the subsequent steps.

In this embodiment, the temperature of the sample stage 105 is raised at a discharge interrupt time to keep high the temperature of the sample stage 105 or the wafer 104 placed thereon to quickly remove the gas or related byproducts adhered to, or remaining on, the upper surface of the wafer 104 and used in the previous step. The temperature at the discharge interrupt time, though dependent on the condition, is set to 60° C.-120° C. in this example. The time during which this temperature is maintained, also dependent on the condition, is set to 10 to 20 seconds.

In the application of the temperature control described in the above embodiments to the working process for a laminated layer structure, etched patterns having vertical side walls and only slight errors in photographic patterning could be obtained even after a relatively long idling time. The same results could be obtained when this temperature control method was applied to the case where the idling time is relatively short between the dismounting of a wafer 104 from and the mounting of the next wafer on, the sample stage in the continuous etching process and the case where the no-wafer cleaning is performed for a lot.

According to this invention, etching could be achieved with throughput and precision higher than those attained with the conventional similar techniques.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing apparatus that has a sample stage, which is provided in a processing chamber arranged in a vacuum chamber, for continuously processing a plurality of samples using plasma generated in said processing chamber, said plasma processing apparatus comprising:
said sample stage on which a disk-like sample to be processed is mounted; and
an adjustment unit for adjusting a temperature of said sample stage to a predetermined value higher than a temperature at which the sample is processed during a processing time of the sample.

2. A plasma processing apparatus as claimed in claim 1, further comprising a heater provided in the sample stage as said adjustment unit, wherein the temperature of the sample stage is adjusted to the predetermined value by means of the heater.

3. A plasma processing apparatus as claimed in claim 1, wherein the predetermined value is previously selected independent of the conditions for processing the plural disk-like samples.

4. A plasma processing apparatus as claimed in claim 2, wherein the predetermined value is previously selected independent of the conditions for processing the plural disk-like samples.

5. A plasma processing apparatus as claimed in claim 1, wherein the heater, which works as said adjustment unit, is a film-like heater embedded in the dielectric layer which is disposed on the sample stage and on the upper surface of which the sample is mounted.

6. A plasma processing apparatus as claimed in claim 2, wherein the heater, which works as said adjustment unit, is a film-like heater embedded in the dielectric layer which is disposed on the sample stage and on the upper surface of which the sample is mounted.

7. A plasma processing apparatus as claimed in claim 3, wherein the heater, which works as said adjustment unit, is a film-like heater embedded in the dielectric layer which is disposed on the sample stage and on the upper surface of which the sample is mounted.

8. A plasma processing method wherein plural disk-like samples, each of which is placed for processing on an upper surface of the sample stage located in the processing chamber housed in the vacuum chamber, are continuously processed with plasma generated in the processing chamber, comprising the step of:
adjusting a temperature of the sample stage to a predetermined value higher than a temperature at which the samples are processed, during an idling time between the successive processes.

9. A plasma processing method as claimed in claim 8, wherein the temperature of the sample stage is adjusted to the predetermined value by means of a heater provided in the sample stage.

10. A plasma processing method as claimed in claim 8, wherein the predetermined value is previously selected independent of the conditions for processing the plural disk-like samples.

11. A plasma processing method as claimed in claim 9, wherein the predetermined value is previously selected independent of the conditions for processing the plural disk-like samples.

12. A plasma processing method as claimed in claim 8, wherein the heater is a film-like heater embedded in the dielectric layer which is disposed on the sample stage and on the upper surface of which the sample is mounted.

13. A plasma processing method as claimed in claim 9, wherein the heater is a film-like heater embedded in the dielectric layer which is disposed on the sample stage and on the upper surface of which the sample is mounted.

14. A plasma processing method as claimed in claim 10, wherein the heater is a film-like heater embedded in the dielectric layer which is disposed on the sample stage and on the upper surface of which the sample is mounted.
